(19) United States
(12) Patent Application Publication
(10) Pub. No.: US 2014/0129925 A1
(43) Pub. Date: May 8, 2014

(54) BROWSER INLINE HTML ADAPTATION

(71) Applicant: Igor Faletski, Vancouver (CA)

(72) Inventor: Igor Faletski, Vancouver (CA)

(21) Appl. No.: 14/075,957

(22) Filed: Nov. 8, 2013

Related U.S. Application Data
(60) Provisional application No. 61/724,252, filed on Nov. 8, 2012.

(51) Int. Cl. G06F 17/22

(52) U.S. Cl. CPC G06F 17/2247
USPC 715/234

(57) ABSTRACT

An inline adaptation system is described herein that selectively and dynamically transforms a web page before resource fetching and page rendering is complete. The system can run in the web visitor's browser in near real-time and at the same resource Uniform Resource Locator (URL) as the desktop site. All, some, or none of the original content from the page may be used during this transformation. The system's approach is selective (i.e., conditionally applied) and prevents rendering of the page before transformation is complete. The system can prevent unwanted external resources from being loaded by the mobile browser and the application of templates on the client-side using a data query engine that allows the origin website to be treated as an Application Programming Interface (API). Thus, the inline adaptation system allows an optimized viewing experience on a variety of platforms without unnecessary effort by web page designers.

### CROSS-REFERENCE TO RELATED APPLICATIONS

The present application claims priority to U.S. Patent Application No. 61/724,252 (Attorney Docket No. MOBIFY004B) entitled “BROWSER INLINE HTML ADAPTATION,” and filed on 2012 Nov. 8, which is hereby incorporated by reference.

### BACKGROUND

Sophisticated computing devices with touch screen displays are increasingly common. The display sizes for these devices is widely divergent and often ranges from 1.5″ to 40″+. These devices include smart phones, touch kiosks, as well as other popular devices such as the Apple iPad. Most of these devices have access to a wireless data network, and include support for internet services such as web browsing. To accommodate browsing with a small screen size, most modern devices with small touch screens support an interaction method called ‘pinch/zoom’. In this interaction method, a document is assigned a virtual canvas that is larger than the actual display resolution of the device. The display interacts with this virtual canvas by behaving like a keyhole that can be moved from side to side to view specific content, moved forward to view specific pieces of content at high zoom, or back to view the entire content at limited resolution. At the other end of the screen-size spectrum, large devices such as computers with large high-resolution monitors (24″+) typically show web content in a window occupying a limited region of screen real estate. Users of these devices do not typically make the browser wider than a typical resolution of 1024 pixels because most websites are not designed to make use of the extra width.

Web publishing is the business of producing content in the form of written text and images on the web. In this industry, revenue is often generated with contextually or behaviorally targeted advertising. Banner advertisements are placed across the top of the content and other advertisements may be located along the sides of, bottom of, or inline with the content. Publisher-created advertising spaces are called inventory. Publishers may fill this inventory a number of different ways including working directly with an advertiser or advertising agency, or through advertising networks such as Google Adsense, and Admob that connect publishers and advertisers. Advertising networks fill publisher inventory with media buys from advertisers. When publisher sites are viewed on small screen devices using the pinch/zoom metaphor, visitors will tend to zoom on areas of the display where there is content relevant to the visitor. This prevents advertising monetization as the advertisement is either off screen or is not presented at the size intended by the advertisement designer. This results in sub-par monetization. Effective mobile-optimization of publishing sites can dramatically improve the effectiveness of advertising and adds value.

Ecommerce is the purchasing of goods or services over the internet. Ecommerce transactions were valued at $143 billion in 2010 by Comscore with growth projected to double through 2015. Mobile ecommerce, sometimes called mcommerce, is ecommerce where the client is interacting with an ecommerce vendor by means of a mobile device such as a smartphone or tablet. Ecommerce sites typically have script-heavy websites that include sophisticated functionality implemented using client-side scripting (e.g., via JavaScript), in addition to a large number of images and external resources. This presents a number of challenges for mobile devices that are battery powered and have limited processing power, limited bandwidth on wireless networks, as well as limited screen space. First, the sites may perform very slowly due to bandwidth and processing power constraints. Second, the limited screen size makes interaction difficult. The visitor navigates with pinch/zoom through the site and completes input fields such as product selection, address, and payment information, where these data fields may be located anywhere on the page. In ecommerce and m-commerce, slow page load times are directly correlated with incomplete transactions. Furthermore, the more difficult the website interaction is for the visitor, the more likely it is that the visitor will “exit” the site, browsing elsewhere. Visitors with large screens on the other hand are not able to make the most of their available screen space, and ecommerce vendors miss valuable opportunities to cross-promote other products in screen areas that are not available to visitors with standard-sized displays.

### DETAILED DESCRIPTION

An inline adaptation system is described herein that selectively and dynamically transforms a web page before resource fetching and page rendering is complete. In some embodiments, the system provides a using a client-side web browser framework. The system can run in the web visitor's browser in near real-time and at the same resource Uniform Resource Locator (URL) as the desktop site. All, some, or none of the original content from the page may be used during this transformation. The system's approach is selective (i.e., conditionally applied) and prevents rendering of the page before transformation is complete. The system can prevent unwanted external resources from being loaded by the mobile browser and the application of templates on the client-side using a data query engine that allows the origin website to be treated as an Application Programming Interface (API). The system can be used on a variety of platforms, such as those having a web browser with a JavaScript engine, including desktop, laptop, smartphone, and tablet web browsers, among others. Thus, the inline adaptation system allows an optimized viewing experience on a variety of platforms without unnecessary effort by web page designers.

As discussed above, the inline adaptation system can prevent a web page from being rendered before transformation occurs. In some embodiments, the system does this by applying a JavaScript API call, document.write, in a novel way. As per the Hypertext Markup Language (HTML) specification, JavaScript is executed inline in a webpage as the webpage is being loaded. Document.write is a method that allows arbitrary HTML to be “written” into the page immediately after the script that contains the document.write API call. This allows the system to insert content that can escape the remaining content of the page. Examples of such content are the HTML tags <style> and <textarea>, and the system can be configured to use either. These can be applied both in the HEAD section of the document and the document BODY section as well as a strategy for consuming all of the origin HTML into a safe buffer that can be used as a data source, all of which takes place before resource fetching and page rendering occurs. Typically, a page load may take some time to complete as the browser renders the page, however, with all content escaped there is no content to render and page load takes place almost immediately, at this point the transformed content can be re-injected for rendering. Thus, in one sense the system intercepts the original content, transforms it, and renders a derived set of content based on the original content.

In some embodiments, the inline adaptation system provides a data query engine to web developers for selecting the content they would like to have re-injected into the page. Since the original content of the page is not rendered, it is placed in a buffer where it can be parsed and extracted using selectors. These include standard Cascading Style Sheets (CSS) version 3 selectors, as well as more powerful filtering and selecting tools similar to those provided by jQuery and other web frameworks. The output of the queries can be placed in a dictionary-like context variable that is input into the template engine described herein.

In some embodiments, the inline adaptation system selectively loads external assets. By preventing the page from rendering, as described above, it is possible to selectively load external files such as images, scripts, and style sheets to limit the size of the page to the a smaller set of elements for mobile devices. A configuration file provides a standardized mechanism for re-inserting elements removed from the original HTML using a client-side template. External data elements to be re-injected can be selected using the data query engine described herein, the same as any other elements or HTML.

The transformations used by the inline adaptation system can be selectively applied (e.g., included for some visitors and not for others). Transformations can be applied on the basis of requesting device type, requesting device browser, or properties of the device or browser such as screen resolution, feature support, or display size. Some transformation may also occur on the server, however, often the server receives only a limited set of information compared to clients during a standard HTTP request. This support allows users of the system to target devices that will generate the most revenue from transformations applied by the system.

In some embodiments, the inline adaptation system provides dynamic rendering. The system can transform a page based on characteristics of the device accessing the page. Tablet-based devices can be given near full-screen desktop experiences, but can replace certain elements such as photo galleries or story elements with touch/swipe-friendly widgets. Mobile devices can be given a mobile-optimized rendering, including laying out site content in a single column, ensuring that site content fits the width of the screen of the device, and so forth.

In some embodiments, the inline adaptation system provides a template engine on the client side. The template engine allows the system to select the type of page based on the nature of the data harvested from the origin HTML. After template selection, the template can be populated with data from the origin page using a custom data query engine described herein. For example, the system may determine that the original page is a common three column format and apply a template that includes information for converting the page to a single column format.

In some embodiments, the inline adaptation system integrates API feeds. Data feeds provided by the host website or by a third party (e.g., via JavaScript Object Notation with Padding (JSONP)) can be integrated with the system. Examples of this kind of data feed include geolocation data to position mobile visitors, store location data, inventory and inventory status, and other types of information.

In some embodiments, the inline adaptation system is used on websites, such as ecommerce or publishing sites, and runs in the web browser (e.g., the client) of a site visitor. Developers create a configuration file for the mobile platform or other particular adaptations of the site that contains templates, style in the form of a web-standard CSS style sheet, and specify data query selectors that will route data from the original HTML into the mobile templates.

In some embodiments, the inline adaptation system is deployed on a Content Delivery Network (CDN) as a static file that is a compiled build of the site-specific configuration, templates, and the browser inline HTML adaptation software platform. The system is activated on the target site by means of the insertion of a set of tags into different locations of the web server's pages. In some cases, the system provides security benefits. The JavaScript file is static, so it does not need to be dynamically generated. As an external resource to the site, the JavaScript file can be served from the secure CDN. All data communication remains routed directly between the mobile client and the origin web servers. No transaction data need be communicated to any additional servers or through any other channel. Serving the file statically also means much lower complexity for file serving. Static web servers are extremely robust and easy to replicate for distributed file delivery.

Following are several use cases for the inline adaptation system. The first case is that of an m-commerce site applying the system. A typical ecommerce company has a website that includes product pages available over the HTTP protocol, findable using a combination of search landing pages, internal search pages, category pages, and links from the site homepage. The site will also typically include a secure checkout flow using the HTTPS or other protocol where a visitor can enter address and payment information to order the offered products or services. If the ecommerce engine used by the site does not have a mobile optimized checkout, the site owner is missing sales from a growing number of mobile visitors.

The inline adaptation system described herein can be used in this scenario to transform the site into a mobile optimized site. The ecommerce company has invested substantially into the business logic, design, and flow of their desktop website. This investment represents their online presence and brand. The system can use all of the business logic of their investment, and where appropriate integrate a similar user experience into the mobile site. The system can apply templates that will dramatically improve the usability of the site on mobile phones and other small screen devices. These templates dynamically add and remove content by changing the way the page is designed directly from the client's browser.

The second use case illustrated herein is that of a website that needs a mobile transformation. The inline adaptation system can be applied to any website, not just an m-commerce site, although it is well suited to m-commerce sites. Publishers can apply a layer of transformations over top of the main site to produce a mobile version. Mobile can include devices typically classed as mobile devices, such as smart phones or tablet computers, or any device used in a mobile context (user movement is not restricted by the physical characteristics of the device).

In another example use case, the inline adaptation system can be used for extensive NB testing, rewriting any and all content on a page before the page is rendered. For example, for some visitors the system can transform a base set of content to a first version of the site (the A version), while for another set of visitors the system can transform the base set of content to a second version of the site (the B version). Based on results (e.g., sales, time on page, and so on) received from each version, the publisher can make determinations about which version is preferred by users.

In another example use case, the inline adaptation system can be applied to inject additional content on devices with large displays and browser windows with above average numbers of pixels. The additional content can take any form—additional product images, additional product data, more article content, promotional material for cross-promoting other products from the site, advertisements for related products, and so forth. The system can also be used to transform a document into a print-friendly format or to transform content for browsing on a television or gaming console without a full keyboard.

As described herein, the inline adaptation system provides a generic framework for selectively and dynamically applying templates to web pages at a client, that is, in the browser that is rendering the page. The system can do this selectively because the system can determine what the device and device characteristics are of the viewing device, something that is more difficult and often not possible to do at the server. Some devices may run the transformations, and others not, depending on their characteristics. The changes are dynamic because when the system does apply transformations, those transformations are dependent on properties of the device viewing the page and based on the content of the page itself. For example, a visitor with a large screen can load additional cross-promotion sidebars, whereas a visitor on a mobile phone may receive only a single column of content formatted to fit their screen.

The inline adaptation system can also use a technique that effectively “escapes” the HTML as it is loaded from the origin web server, which prevents undesired HTML from ever being rendered by the browser. For mobile or other devices, this can result in a substantial savings as unneeded resources are not retrieved and thus do not consume network bandwidth or limited resources of the client device. The inline adaptation system is able to modify the document object model (DOM) tree, to add and remove content from a page arbitrarily. The system can selectively choose which resources to load and can even change the order in which resources are loaded.

Thus, in some embodiments, the inline adaptation system delivers a “device-optimized” web experience from an existing ecommerce site with no changes to back-end business logic, no integration with database or other API integration, and no additional server-side software layer.

I/We claim:

1. A system as substantially shown and described herein, and equivalents thereof.

2. A method as substantially shown and described herein, and equivalents thereof.
